(19) United States
(12) Patent Application Publication
(10) Pub. No.: US 2026/0252665 A1
(43) Pub. Date: Aug. 27, 2026

(54) DATA MAPPING USING EMBEDDING VECTOR SIGNATURES OF SUB-EMBEDDING COMPONENTS

(71) Applicant: Cotiviti, Inc., South Jordan, UT (US)

(72) Inventors: Maryam Najafi, Melbourne, FL (US); Abhinav Prasad, Edison, NJ (US)

(21) Appl. No.: 19/543,412

(22) Filed: Feb. 18, 2026

Related U.S. Application Data
(60) Provisional application No. 63/763,094, filed on Feb. 25, 2025.

(51) Int. Cl. G06F 18/22; G06F 17/14

(52) U.S. Cl. CPC G06F 18/22; G06F 17/142

(57) ABSTRACT

Improved data mapping accuracy can be achieved by hybrid techniques incorporating both unsupervised and supervised learning similarity determinations based on sub-embedding signal components. In an example method, name embeddings for source and destination fields are generated and then decomposed into frequency components (e.g., via Fast Fourier Transform) and probability distribution components (e.g., via Gaussian Mixture Models). Distance measures between the name embeddings and their component decompositions are determined. The distance measures along with the name embeddings (and corresponding component decompositions) are provided to a trained machine learning (ML) model that is configured to provide a similarity measure or score for each pairing between a source field and the destination fields. Data mapping can then be performed based on the similarity measures.

### CROSS-REFERENCE TO RELATED APPLICATIONS

This application claims priority to, and the benefit of, U.S. Provisional Application No. 63/763,094 titled “Embedding-Based Mixture of Expert Models with Fourier Transform for Data Mapping” and filed on Feb. 25, 2025. The contents of the aforementioned application are hereby incorporated by reference in their entireties.

### BACKGROUND

Difficult problems occur with data mapping when different parties define same data in different manner or names. For example, different datasets may define or label date-of-birth information as “DOB” or “DT” or “Birth Date.” Another example is medical diagnosis codes that some datasets may define or label as “dcd” while other datasets may use a different label. The problem is compounded by the large number of these fields, as well as the large number of different datasets associated with different parties or clients defining definition or label schemes. Processing multiple datasets at a central location or system requires that this variety of very short and poorly encrypted tokens in multiple sources be mapped onto a unified and well-formatted destination.

An existing solution to these data mapping challenges includes manual mapping, which is a time-consuming process which has been reported to take roughly ninety days per dataset. Other non-manual solutions include certain algorithms. One example is cosine similarity, which is used to compare two vectors and thus their corresponding tokens. Cosine similarity loses its strength tackling challenging datasets in which tokens are encrypted and in a closed form, possibly due to the vector representation of the tokens not being as robust with respect to the encrypted forms. A need exists for improved solutions to data mapping challenges.

### BRIEF DESCRIPTION OF THE DRAWINGS

FIG. 1 is a block diagram showing an example system for unsupervised and hybrid techniques of data mapping based on sub-embedding component information, according to certain embodiments of the present disclosure.

FIG. 2 is a block diagram showing modeling of an example system for a hybrid data mapping technique using sub-embedding component information, according to certain embodiments of the present disclosure.

FIG. 3 shows example results comparing an unsupervised data mapping techniques with a hybrid data mapping technique, according to certain embodiments of the present disclosure.

FIG. 4 shows example results demonstrating a contribution of a type of sub-embedding component information to hybrid data mapping performance, according to certain embodiments of the present disclosure.

FIG. 5 shows an example of frequency spectrum bucketing for comparison of source field and destination field embeddings, according to certain embodiments of the present disclosure.

FIGS. 6A-6B are flow diagrams that include example operations for data mapping with sub-embedding component information, according to certain embodiments of the present disclosure.

FIG. 7 is a block diagram that illustrates an example of a computing platform and components thereof for implementing certain embodiments of the present disclosure.

### DETAILED DESCRIPTION

Embodiments disclosed herein provide solutions for data mapping challenges, or mapping one type of data to another that have field names defined and described by one party to another. Example embodiments include a mixture of unsupervised and supervised learning models and uses fast Fourier transform (FFT) and Gaussian Mixture Models (GMM) over embeddings to assist the supervised learning models. Example embodiments provide artificial intelligence or machine learning (ML) based techniques to map several different data formats (e.g., varied definition and acronym/field names that sometimes are accompanied by description) to a unified format and vice versa.

The vector representation of a token has been a popular topic in natural language processing for many years. There are some different embedding techniques to transform a textual input into its numerical form such as Word2Vec, TF-IDF, and GloVe. Embodiments herein provide an improved embedding model that represents an input token in a high dimension numerical vector (e.g., of length 1024) using the dense embedding layer of the autoencoder and combines a numerical embedding with sub-embedding component information.

The dense vector of two matching tokens represents a set of matching sets of sinusoidal waves. A token can be interpreted as an interpolated signal within a periodic signal. Therefore, adding or removing a token to the embedding vector is supposed to be reflected as an additional or missing interpolated signal to the base waves. A raw/source field name as the fundamental wave would have matching destination tokens where the destination tokens are a mixing of harmonics of the raw field's fundamental wave and an interpolation of the extra tokens with the raw field. It is more challenging to detect matching tokens in the presence of additional or missing tokens interpolated with the original signal.

There are multiple approaches to capture different patterns in a vector. In the present disclosure, two main approaches are presented, both of which are based upon the presence of analogous patterns in the matching dense vectors. In the vector space, an embedding vector has a range of numerical values that are characterized by using a single Gaussian kernel across all samples or a mixture of multiple Gaussian models. Thus, for example, an embedding vector can have one or more Gaussian distribution components. In the Fourier space, an embedding vector has a mixture of signals on a frequency spectrum and is characterized by its magnitude frequencies. Thus, for example, an embedding vector can have one or more frequency components. Both approaches provide a signature of the embedded vector that can be used in Probabilistic Generative Models.

Thus, disclosed approaches employ advanced techniques to address gaps observed in existing techniques such as cosine similarity. In some embodiments, several other features are engineered based on the probabilistic distribution components and/or frequency components of an embedding and used alongside cosine similarity. This can be done for model training/testing/validation and for model inference. Each mapping pair can be represented in the form of multivariate vectors of raw/source and destination embedding vectors and injected directly to a supervised learner. In addition, each vector can be transformed into the Fourier domain to enforce sinusoidal characteristics of the numerical representation of the input tokens. Alternatively or additionally, each vector can be processed using a Gaussian mixture model (GMM) to determine the one or more Gaussian distributions present within each vector. The techniques disclosed herein can be used to address challenges in which a variety of very short and poorly encrypted tokens in multiple sources that should be mapped onto a unified and well-formatted destination, as exemplified in Table 1 below, which shows an example of two different datasets with their raw fields mapped onto destination fields.

TABLE 1

| GDF | RAW | DATASET |
|---|---|---|
| CD_SUBMITTED_REVENUE_CODE | rcrc_id | A |
| CD_SUBMITTED_REVENUE_CODE | revenue_code | B |
| CH_OCCURRENCE_DATE_08 | clho occ from dt 8 | A |
| CH_OCCURENCE_DATE_08 | occur_date | B |
| CH_SUBSCRIBER_NAME_SUFFIX | sbsb_title | A |
| CH_SUBSCRIBER_NAME_SUFFIX | memb_subscriber_full_name | B |
| CM_SUBSCRIBER_CLIENT_ID | sbsb_id | A |
| CM_SUBSCRIBER_CLIENT_ID | subscription_hcc_id | B |
| CP_PROVIDER_CLIENT_MASTER_ID | prprid | A |
| CP_PROVIDER_CLIENT_MASTER_ID | practitionerhccid | B |

According to some embodiments, the present data mapping solutions are hybrid techniques, incorporating both an unsupervised stage and a supervised stage. Example unsupervised models or techniques that may be implemented in the data mapping solution can include the following:
Vector embedding based similarity search;
Enhanced embeddings that combine field/variable name with its definition and further augmented by embeddings of description;
An ensemble of embedding models of different sizes; and
Similarity of embeddings based on both cosine distance as well as at least one of Fourier Transform (FT) frequency distance or GMM distance. GMM estimates the density of distribution as a mixture of multiple Gaussians and each of these Gaussians have their mean and standard deviations.
Thus, for example, similarity candidates can be determined for a dataset field based on these unsupervised determinations or evaluations of embedding vector similarity (e.g., the vectors which can embed field definition/description, vectors from an ensemble of embedding models) and of sub-embedding component similarity (e.g., FT frequency distance, GMM distance).

The supervised stage may include deep neural networks (DNNs) or Gradient Boosted Trees or an ensemble of these. In some embodiments, a supervised stage or module uses an output from an unsupervised learning stage or module. For example, along with the embeddings as an input parameter, derived embeddings—such as FFT (Fast Fourier Transform) transformations and GMM outputs of the embedding vectors—can be included as input parameters

In some embodiments, the output of the supervised stage or unsupervised stage can be used independently for the data mapping.

Algorithm 1 below shows an example pseudo code from the feature engineering to the training and evaluation. The input of the algorithm is a 2-d vector consisting of field name and its corresponding description. The objective is to traverse over each row of the input matrix and map the field name to the nearest raw field names. In some examples, an arbitrary number of nearest neighbors returning top possible mappings can be determined by the user.

ALGORITHM 1

Given a 2d - vector of Payor Raw Fields named X
; where X ∈ X^{all}, representing Payor Universe, and consists of name and description
,and G that represents the Global Fields and consists of name and description
,and GT as ground truth of valid < X,G > mappings.
init.

```
  distance metric = ‘cosine’
  k nearest neighbor = k
  STOPWORD REMOVAL(X[desc],G^{f}[desc]) → X,G
  STRIP(X[name]) → X
  X[name] + X[desc] → X[desc]
  G[name] + G[desc] → G[desc]
  feature space:EMBED(G,‘name’) → vector space:G̅
  feature space:EMBED(X,‘name’) → vector space:X̅
```

Do

| | |
|---|---|
| 1. | for X in X^{train}, |
| 2. | similarity(X̅,G̅) → sim |
| 3. | Fourier space:magnitude(FFT(X̅)) → fft_{X̅} |
| 4. | Fourier space:magnitude(FFT(G̅)) → fft_{G̅} |
| 5. | K(fft_{X̅}) → μ_{X̅}, σ_{X̅} |
| 6. | K(fft_{G̅}) → μ_{G̅}, σ_{G̅} |
| 7. | δ(μ_{X̅}, μ_{G̅}) → δ̅_{μ} |
| 8. | δ(σ_{X̅}, σ_{G̅}) → δ̅_{α} |
| 9. | for x in X₁ |
| 10. | y* = 1 if GT(x,G) otherwise,y* = 0 |
| 11. | X̅ + G̅ + δ̅_{μ} + δ̅_{α} + category + y* → trainset |
| 12. | CLASSIFY(trainset,classifier_{c}) for c = {1, ...,num classifiers} → ŷ_{c} |
| 13. | softmax(ŷ_{c},k) → ŷ |
| 14. | ACCURACY(ŷ,y*) → acc |

During the embedding process to migrate from feature space to vector space, the input tokens are transformed from their textual form to their numerical representations. According to some embodiments, the numerical representations (e.g., embedding vectors) can be obtained using one or more different embedding models. Then, a similarity metric/measure can be determined between the numerical representations of the input tokens, and this similarity metric/measure can be one of the unsupervised data mapping outputs. In some embodiments, the similarity metric in the vector space is cosine similarity. Either similarity metric or a distance metric by subtracting the cosine similarity index from 1 would provide a solid comparison between two multivariate vectors.

As the initialization of the algorithm, there are two main input parameters: embedded vector of the raw/source field names and the embedded vector of the all the destination field names. In an ideal scenario, every destination field name would be mapped to at least one raw field name. In the real-world scenario, not all the destination fields have a corresponding matching raw/source field in the dataset. Thereby, in the test case scenario. some destination fields are forced to map to irrelevant source fields. However, this is not a problem in the training scenario because the ground truth is determined in advance and is a subset of the destination field set.

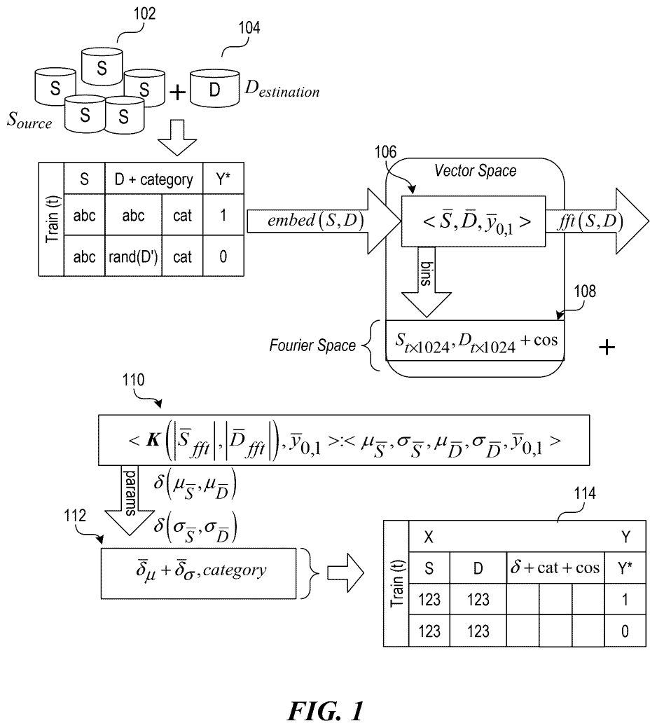

FIG. 1 depicts an example system for data mapping based on sub-embedding component information. The example system can both incorporate an unsupervised data mapping technique and facilitate a hybrid (unsupervised and supervised) data mapping technique. The system for data mapping can be implemented to map, pair, associate, and/or the like source fields in one or more source datasets 102 to destination fields in a destination dataset 104. Using Table 1 as an example again, source datasets 102 may identify subscriber name information as “sbsb_title” or “memb_subscriber_full_name,” while a destination dataset 104 (which may facilitate uniform processing of source dataset data) identifies subscriber name information as “CH_SUBSCRIBER_NAME_SUFFIX.” According to example data mapping techniques, these source fields in the source datasets 102 can be mapped to a destination field in the destination dataset 104 with improved accuracy.

The system as illustrated in FIG. 1 depicts the generation of a training dataset for a supervised learner, but it will be understood that the system can be used to create testing datasets, validation datasets, and/or prediction datasets (e.g., unknown candidates to be classified/predicted by the supervised learner as mapped or not mapped). As shown in FIG. 1, a source field of a source dataset 102 can be paired with a destination field of a destination dataset 102. For training purposes, this can be a known or ground truth pairing (as reflected by a positive label Y* of I), whereas when using the system to perform data mapping predictions/inferences, the destination field is a candidate (with the label Y* being the predicted output). In some embodiments, as illustrated, the pairing of source field and destination field can be accompanied with a category, a definition, a description, and/or the like of either field.

Then, an embedding vector 106 can be generated for the source field and the destination field. This embedding vector 106 is based at least on the textual tokens of the source field's name and the destination field's name, and thus, this embedding vector 106 can be a name embedding. According to some embodiments, multiple embedding vectors 106 can be generated using different embedding models. For each source and destination field pair, a cosine similarity measure 108 is calculated from the embedding vectors 106. When there are multiple embedding vectors 106 generated for the source and destination fields, the cosine similarity measure 108 can be used to rank the different embedding models/vectors and remove outliers (or select preferred embeddings).

The present technology improves upon data mapping accuracy by incorporating sub-embedding vector/signal components, such as frequency components and/or probability distribution components. Accordingly, the system transforms the embedding vectors 106 from vector to Fourier space by taking the magnitude of their Fast Fourier Transform (FFT), thus obtaining frequency representations 110 of the embedding vectors 106. In the Fourier domain, the average and variance of each FFT spectrum are calculated. These parameters of the frequency representation 110 of an embedding vector 106 can represent or function as a signature of the embedding vector. Additionally or alternatively, the system can analyze the embedding vectors 106 using a Gaussian Mixture Model (GMM) to obtain the probability distribution components of the embedding vectors 106.

Next, distance measures 112 (δ) can be determined based on the frequency representations 110 of the embedding vectors 106 (and/or based on the probability distribution information of the embedding vectors 106 determined via GMM). For example, the average/mean (μ) and variance (σ) of the frequency representations 110 associated with the source field and the destination field is calculated and used for the distance measures 112. In some embodiments, a distance measure 112 can be determined with respect to frequency representation average and another distance measure can be determined with respect to frequency representation variance. For probability distribution information determined via GMM, for example, the distance measures 112 can compare the average/mean and the standard deviation of the one or more Gaussian distributions identified within the source field embedding and the destination field embedding.

At least a subset of these determinations/outputs can be combined together to form feature vectors 114 to be input into a supervised machine learning (ML) model (e.g., for training or retraining the model, for prediction/inference by the trained model). The feature vectors 114 represent and correspond to the pairs of source field and destination field. In some embodiments, a feature vector 114 can include the embedding vector 106 of the source field, the embedding vector 106 of the destination field, the cosine similarity measure 108, and at least one distance measure 112 determined based on the frequency components or probability distribution components of the respective embedding vectors. In one example, a single feature vector 114 or input data point for modeling is defined as two embedding vectors (numerical), their cosine similarity (numerical), the original source from which the raw field was derived (categorical—e.g., Provider, Member and Claims), and six statistics on the Fast Fourier Transform of the embedded vectors: the average and variance of the FFT transforms of destination and source embedding vectors, the difference of average values of the two transforms as well as the difference of variance values of them. As discussed, probability distribution information or statistics as determined via GMM can also be included in a single feature vector 114.

In some embodiments, the feature vectors 114 can be collected together to form an input matrix, thus allowing the supervised ML model to learn and rely upon cross-pairing and dataset wide patterns or information. In some examples in which multiple source datasets 102 need to be mapped to the destination dataset 104, the system of FIG. 1 can process each source dataset 102 sequentially.

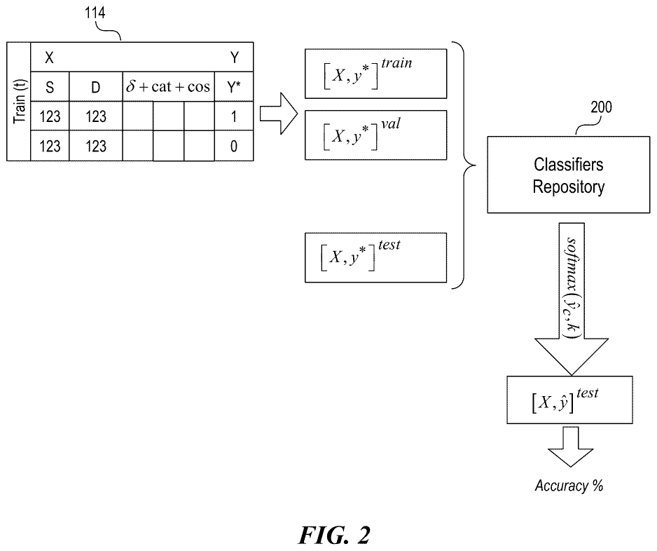

FIG. 2 depicts a system incorporating a supervised learner or ML model that is configured to use sub-embedding component information for data mapping. As depicted, the feature vectors 114 determined according to the technique of FIG. 1 can then be used to form training datasets, validation datasets, and testing datasets for the supervised training of one or more classifier models 200. The classifier models 200 can include deep neural networks (DNN), gradient boosted trees, autoencoders, ensemble models, and/or the like, and each classifier model is trainable such with parameters (e.g., neuron or layer weights) tunable based on each model's processing of the training, validation, and testing datasets. Based on a supervised learning process, the classifier models 200 can be trained to output a predicted label or score (Y) that represents whether a pair of dataset fields should be mapped or associated together or not. In some embodiments, a classifier repository used by a data mapping system can include multiple classifier models 200, and multiple classifier models 200 can be trained and use to provide an ensemble model for data mapping or a ranking system for data mapping.

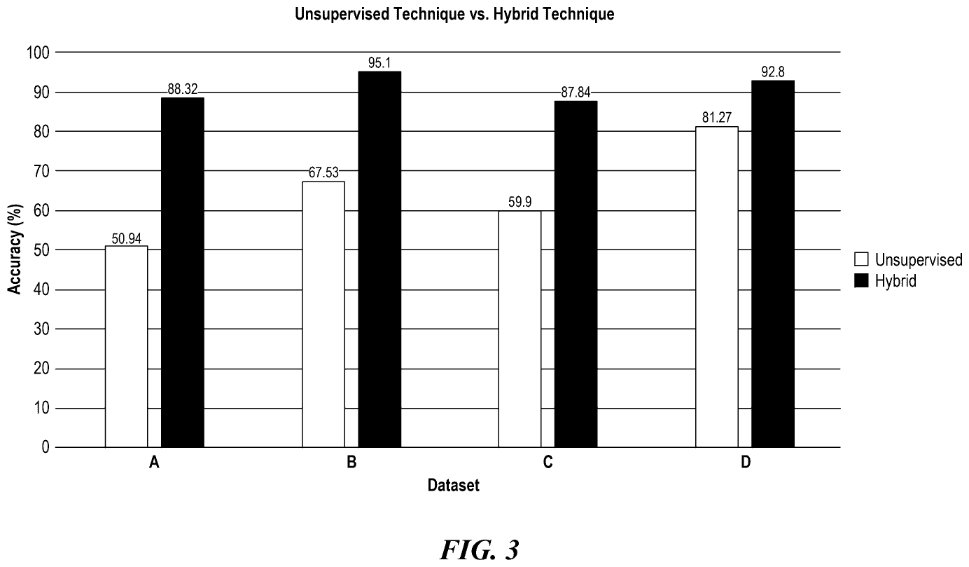

FIG. 3 shows example results of testing the disclosed solutions against datasets. Each of multiple datasets were isolated as the test set, and the best performing models were fit based on the rest of the datasets. The left bars for each dataset shows the accuracy of an unsupervised technique in which just the cosine similarity measures 108 of each pair were utilized to determine the nearest destination fields matching the raw/source fields. The right bars for each dataset show the accuracy of the disclosed hybrid technique where the cosine similarity measures 108 were incorporated alongside additional features such as the two source and destination embedding vectors themselves as well as the sub-embedding component information/statistics (e.g., FFT transform statistics, GMM distribution statistics) from the FFT transform of the embedding vectors. These features are accompanied by the source name from which the RAW fields were extracted from (e.g., Provider, Member and Claims). The total number of features then reduced to 100 based on their importance and produced accuracy. As depicted, the disclosed hybrid technique provides an improved data mapping accuracy for matching each of the datasets (e.g., A, B, C, D) to a given destination dataset.

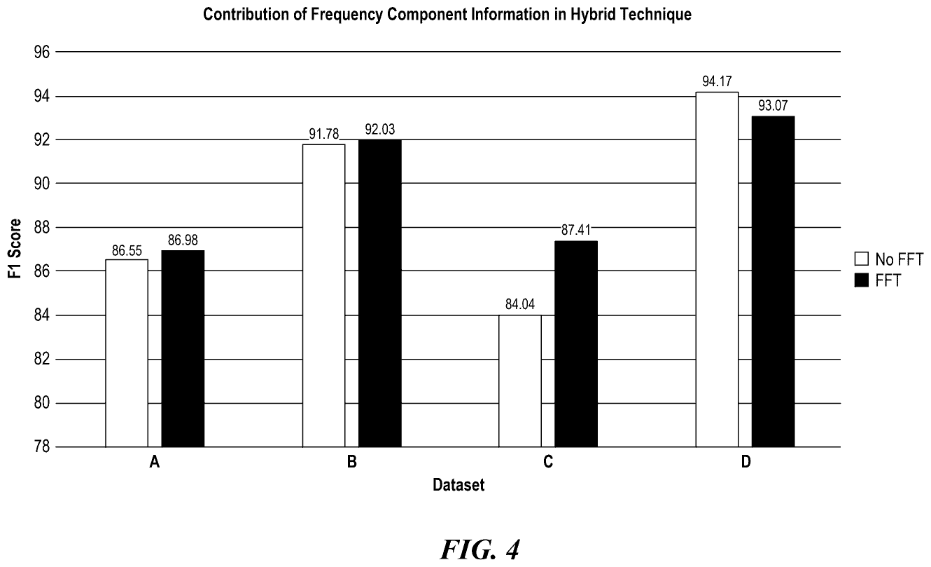

FIG. 4 shows example performance results representing the contribution or impact of the FFT statistics on the data mapping accuracy of the disclosed hybrid technique. The FFT transform of embeddings as additional input guide to the supervised learning model can improve the results by 4% of F1 score. This is especially useful for noisy data or data with high entropy. The models are trained based on isolation of one dataset as test set and usage of the rest for the training purposes. A slight improvement was observed in two of the four datasets whereas the improvement of F1 score in an encrypted dataset was more significant. There is a slight decrease in the F1 score of the fourth dataset.

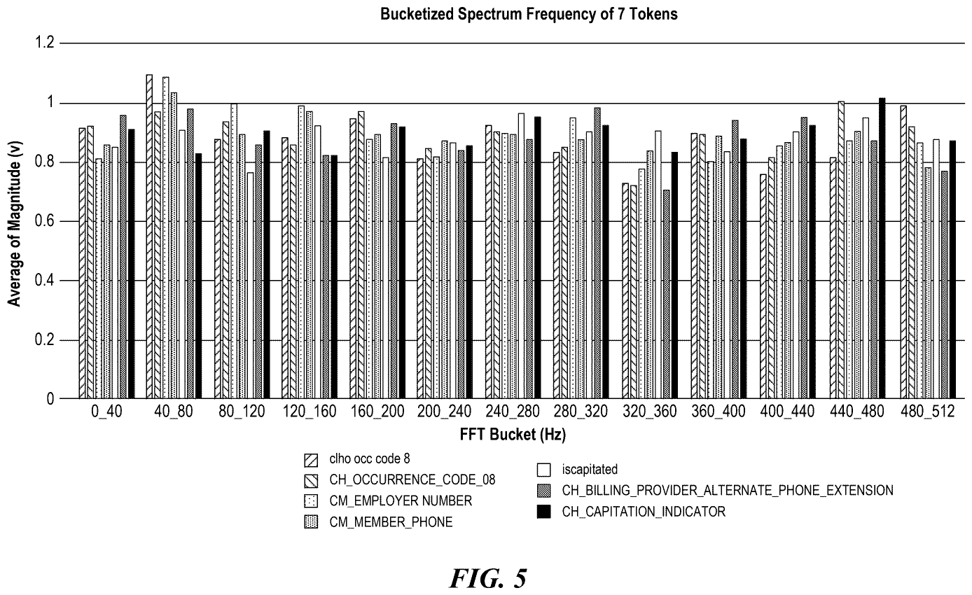

FIG. 5 shows a bucketized spectrum frequency of tokens being compared in an example data mapping technique. By generating multiple frequency spectrum buckets, the FFT information/statistics of two dataset fields can be compared with more resolution with some noise being eliminated. In some embodiments, each bucket size is an empirical user-defined parameter which presents its pros and cons. As far as the pros, it is imposing spectrum analysis per bucket to enforce rare tokens with abnormal distributions, whereas this method introduces a less flexible determination of underlying distribution. In FIG. 5, the two bars in light gray (clho occ code 8 and CH_OCCURRENCE_CODE_08) and two bars in light pink (iscapitated and CH_CAPITATION_INDICATOR) are the only matching pairs that are accepted. Other bars are mismatching or randomly selected tokens that act as noise or negative labels in the modeling. Bucketization implies a single Gaussian distribution within each bucket. This assumption can be made less strict in other embodiments. To remedy such trade-off, an additional layer of kernel analysis can be implemented by adapting a Gaussian Mixture Model (GMM). As a result, each bucket of the spectrum frequency can be represented with multiple sets of averages and variances.

Thus, solutions disclosed herein provide results improvement by adapting a probabilistic generative analysis to create a hybrid approach incorporating a mixture of cosine similarity, embedding vector modeling, and sub-embedding component information (e.g., Fast Fourier Transform statistics, Gaussian Mixture Model statistics). Disclosed approaches have made a significant improvement to a baseline unsupervised model. The usage of experts in conjunction with FFT and/or GMM can make the hybrid approach more robust in tackling fairly encrypted datasets.

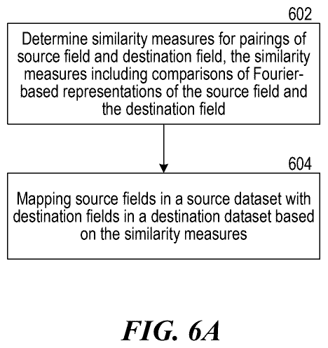

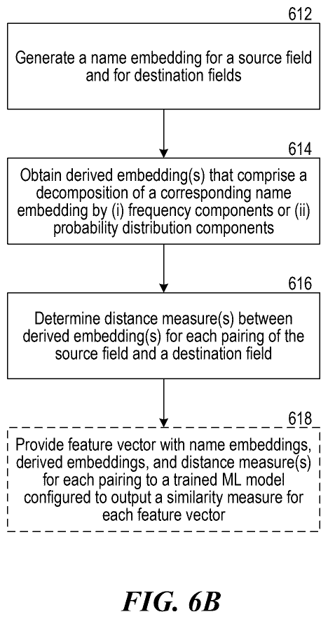

FIG. 6A is a flow diagram that includes example operations for implementing the disclosed solutions, for example, to perform a data mapping between a source dataset having source field names or labels and a destination dataset having destination field names or labels. Referring to other examples disclosed herein, a source dataset may include raw field names, while the destination dataset may include destination field names.

At block 602, similarity measures may be determined for pairs of source field and destination field. Each pair can include one source field from the source dataset and one destination field from the destination field. The similarity measures can include spectra comparison of Fourier-based representations of the source field and the destination field. For example, the similarity measures can include a difference between the average and variation in the fast Fourier transformation spectra of the embedding vectors representing the source field and the destination field. The similarity measures can further include cosine similarity measures or GMM distance measures.

An embedding vector can be understood as a constrained numerical representation of a textual input (e.g., a text string such as a source field name or a destination field name) in the vector space, and a cosine similarity between two vectors determines how analogous they are.

At block 604, a data mapping between the source dataset and the destination dataset may be determined, or the source fields in the source dataset are mapped with the destination fields in the destination dataset, based on the similarity measures. In some embodiments, the similarity measures are provided as input features to a hybrid model comprising an unsupervised stage (comprising models or experts configured using unsupervised learning techniques) and a supervised stage (comprising models or experts configured using supervised learning techniques). In some embodiments, some of the similarities measures may be intermediate outputs or results of the hybrid model (e.g., at an output of the unsupervised stage) based on the embedding vectors of the source fields and destination fields being provided as input.

FIG. 6B is a flow diagram that includes example operations for implementing the disclosure solutions, for example, to prepare and use sub-embedding component information for data mapping. In an example embodiment, the determination of similarity measures according to block 602 in FIG. 6A can be performed based on the example operations depicted in FIG. 6B. In some embodiments, a subset of the operations can be performed to provide an unsupervised data mapping technique with sub-embedding component information, e.g., to skip implementation or use of a supervised ML model.

At block 612, a name embedding is generated for a source field and for each of a plurality of destination fields. In some embodiments, the name embedding is generated by a particular embedding model selected from a plurality of embedding models, or generated by an ensemble model of different embedding models.

At block 614, at least one derived embedding is obtained for each name embedding. A derived embedding comprises or represents a decomposition of the corresponding name embedding by (i) frequency components or (ii) probability distribution (e.g., Gaussian) components. A derived embedding can be a Fourier Transform representation of a name embedding (thus capturing the frequency components of the name embedding) or a GMM output of the name embedding (thus capturing the Gaussian distribution components of the name embedding).

At block 616, distance measures are determined between the derived embeddings of the source field and the destination field of each pairing. In some embodiments, the distance measures can be determined based on a difference in mean and/or variance between the derived embeddings (e.g., of the frequency spectra or frequency components, of the mixed Gaussian distribution components). In some embodiments, the distance measures with respect to the frequency components are determined in a bucketized manner. For example, a frequency spectrum spanned by the derived embeddings can be bucketized into frequency bands or buckets, and a distance measure can be determined for each frequency band/bucket.

According to some embodiments, these distance measures can be used in providing unsupervised data mapping. In some embodiments, this unsupervised output can be used to perform data mapping for certain source datasets to a destination dataset. In other embodiments, a hybrid technique is implemented, and this unsupervised output is fed into a supervised learner. Accordingly, at block 618, a feature vector that includes the name embeddings, the derived embeddings, and the distance measures based on the derived embeddings can be provided to a trained ML model for each pairing of source field and destination field. In some embodiments, the feature vector further includes a cosine similarity measure or a cosine distance between the name embeddings. Each aspect of the feature vector can be concatenated within the feature vector. The ML model can be trained to output a similarity measure for each feature vector, according to its supervised training based on training (/testing/validation) datasets.

Some example technical solutions implemented by example embodiments are listed below.

Solution 1. A method comprising: determining a plurality of similarity measures for pairings between a plurality of source fields in a source dataset and a plurality of destination fields in a destination dataset, the plurality of similarity measures comprising a comparison between respective Fourier transformation spectra of embedding vectors representing the source field and the destination field; and mapping the plurality of source fields in a source dataset with a plurality of destination fields in a destination dataset using the plurality of similarity measures.

Solution 2. The method of solution 1, wherein the mapping is performed using a hybrid modeling comprising at least one unsupervised learning model component and at least one supervised learning component, wherein the plurality of similarity measures is provided to the hybrid modeling as an input.

Solution 3. The method of solution 2, wherein the at least one unsupervised learning model is configured to determine a Gaussian Mixture Model (GMM) distance as one of the plurality of similarity measures.

Solution 4. The method of any one or more of solutions 1-3, wherein the one or more similarity measures further include a cosine similarity measure.

Solution 5. The method of any one or more of solutions 1-4, further comprising: generating an embedding vector representing each source field and each destination field based on text-based descriptions attached to each source field and each destination field.

Solution 6. A method for data mapping between a source dataset and a destination dataset, comprising: generating, by at least one processor, a name embedding associated with a source field of the source dataset and for each of a plurality of destination fields of the destination dataset; obtaining, by the at least one processor, at least one derived embedding for each name embedding of the source field and the plurality of destination fields, wherein a derived embedding comprises a decomposition of the name embedding into (i) frequency components or (ii) probability distribution components; for each pairing between the source field and each destination field, determining, by the at least one processor, at least one distance measure between corresponding derived embeddings associated with the source field and each destination field, to form a feature vector that includes the at least one distance measure and the respective name embeddings; providing, by the at least one processor, the feature vector for each pairing to a trained machine learning (ML) model; and mapping, by the at least one processor, the source field to a particular destination field based on similarity measures that are output by the trained ML model and that correspond to each pairing between the source field and each destination field.

Solution 7. The method of solution 6, wherein the at least one derived embedding for a given name embedding is obtained by applying a Fast Fourier Transform (FFT) to the given name embedding to generate the frequency components or by applying a Gaussian Mixture Model (GMM) to the given name embedding to generate the probability distribution components.

Solution 8. The method of any one or more of solutions 6-7, wherein determining the at least one distance measure between the corresponding derived embeddings that comprise the frequency components comprises: bucketizing a frequency spectrum spanned by the corresponding derived embeddings; and determining bucket-wise distance measures between the corresponding derived embeddings according to a plurality of buckets determined by the bucketizing.

Solution 9. The method of any one or more of solutions 6-8, further comprising: including, in the feature vector for each pairing between the source field and each destination field, a cosine distance between the name embedding associated with the source field and the name embedding associated with the destination field.

Solution 10. The method of any one or more of solutions 6-9, wherein the at least one distance measure between the corresponding derived embeddings is determined based on a difference between a mean or a variance of (i) the frequency components or (ii) the probability distribution components in the corresponding derived embeddings.

Solution 11. The method of any one or more of solutions 6-10, wherein the name embedding for the source field and each destination field and the at least one distance measure for each pairing are concatenated into an input vector for each pairing, the input vector for each pairing being provided to the trained ML model.

Solution 12. The method of any one or more of solutions 6-11, wherein the name embedding for the source field and for each of the plurality of destination fields is generated based on selecting one or more name embeddings out of other name embeddings generated using different embedding models.

Solution 13. A computing system comprising at least one processor and at least one memory storing instructions that, when executed by the at least one processor, cause the computing system to implement a method of any one or more of preceding solutions.

Solution 14. A non-transitory computer-readable medium storing instructions that, when executed by at least one processor of a computing system, cause the computing system to implement a method of any one or more of preceding solutions.

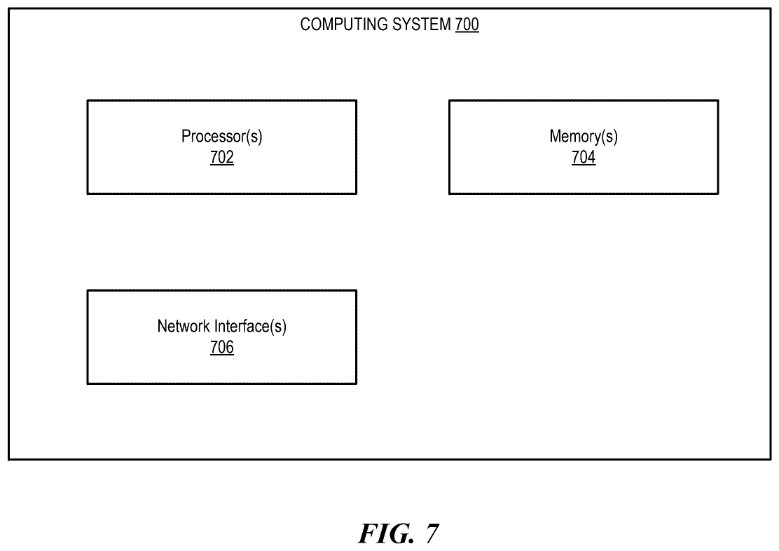

FIG. 7 provides a diagram illustrating an example of a computing system 700 that implements various embodiments described herein. In some embodiments, the computing system 700 implements the solutions disclosed herein, for example, by executing stored instructions to perform various operations and processes described herein.

The computing system 700 includes at least one processor 702 and at least one memory 704 having instructions stored thereupon. The at least one processor 702 and the at least one memories 704 can be co-located within a computing device (e.g., a server, a desktop or computing station, a laptop computer, a mobile device) or can be distributed across multiple computing nodes and/or node clusters. The memory(s) 704 may store instructions to be executed by the processor(s) 702. In other embodiments, additional, fewer, and/or different elements may be used to configure the computing system 700. The memory(s) 704 may be an electronic holding place or storage for information or instructions so that the information or instructions can be accessed by the processor(s) 702. The memory(s) 704 can include, but is not limited to, any type of random access memory (RAM), any type of read only memory (ROM), any type of flash memory, and/or the like, such as magnetic storage devices (e.g., hard disk, floppy disk, magnetic strips, etc.), optical disks (e.g., compact disk (CD), digital versatile discs (DVD), etc.), smart cards, flash memory devices, etc. The instructions upon execution by the processor 702 configure the computing system 700 to perform the example operations and techniques described herein.

The instructions executed by the processor(s) 702 may be carried out by a special purpose computer, logic circuits, or hardware circuits. The processor(s) 702 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instructions, the processor(s) 702 can perform the operations called for by that instruction. The processor(s) 702 operably couples with the memory(s) 704 and network interface(s) 706 to receive, to send, and to process information and to control the operations of the computing system 700. The processor(s) 702 may retrieve a set of instructions from a permanent memory device such as a ROM device and copy the instructions in an executable form to a temporary memory device that is generally some form of RAM. In some implementations, the computing system 700 can include a plurality of processors that use the same or a different processing technology.

The network interfaces 706 transmit and receive information or data to another computing system or device. The network interfaces 706 can include one or more transmitters, receivers, transceivers, and/or the like. Via the network interfaces 706, for example, the computing system 700 can communicate via a wired or wireless network with client computing devices, for example to transmit or receive data related to different datasets, model outputs, and/or the like.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method for data mapping between a source dataset and a destination dataset, comprising:
generating, by at least one processor, a name embedding associated with a source field of the source dataset and for each of a plurality of destination fields of the destination dataset;
obtaining, by the at least one processor, at least one derived embedding for each name embedding of the source field and the plurality of destination fields, wherein a derived embedding comprises a decomposition of the name embedding into (i) frequency components or (ii) probability distribution components;
for each pairing between the source field and each destination field, determining, by the at least one processor, at least one distance measure between corresponding derived embeddings associated with the source field and each destination field, to form a feature vector that includes the at least one distance measure and the respective name embeddings;
providing, by the at least one processor, the feature vector for each pairing to a trained machine learning (ML) model; and
mapping, by the at least one processor, the source field to a particular destination field based on similarity measures that are output by the trained ML model and that correspond to each pairing between the source field and each destination field.

2. The method of claim 1, wherein the at least one derived embedding for a given name embedding is obtained by applying a Fast Fourier Transform (FFT) to the given name embedding to generate the frequency components or by applying a Gaussian Mixture Model (GMM) to the given name embedding to generate the probability distribution components.

3. The method of claim 1, wherein determining the at least one distance measure between the corresponding derived embeddings that comprise the frequency components comprises:
bucketizing a frequency spectrum spanned by the corresponding derived embeddings; and
determining bucket-wise distance measures between the corresponding derived embeddings according to a plurality of buckets determined by the bucketizing.

4. The method of claim 1, further comprising:
including, in the feature vector for each pairing between the source field and each destination field, a cosine distance between the name embedding associated with the source field and the name embedding associated with the destination field.

5. The method of claim 1, wherein the at least one distance measure between the corresponding derived embeddings is determined based on a difference between a mean or a variance of (i) the frequency components or (ii) the probability distribution components in the corresponding derived embeddings.

6. The method of claim 1, wherein the name embedding for the source field and each destination field and the at least one distance measure for each pairing are concatenated into an input vector for each pairing, the input vector for each pairing being provided to the trained ML model.

7. The method of claim 1, wherein the name embedding for the source field and for each of the plurality of destination fields is generated based on selecting one or more name embeddings out of other name embeddings generated using different embedding models.

8. A system comprising:
at least one processor; and
at least one memory storing instructions that, when executed by the at least one processor, cause the system to perform operations comprising:
generating a name embedding associated with a source field of a source dataset and for each of a plurality of destination fields of a destination dataset;
obtaining at least one derived embedding for each name embedding of the source field and the plurality of destination fields, wherein a derived embedding comprises a decomposition of the name embedding into (i) frequency components or (ii) probability distribution components;
for each pairing between the source field and each destination field, determining at least one distance measure between corresponding derived embeddings associated with the source field and each destination field, to form a feature vector that includes the at least one distance measure and the respective name embeddings;
providing the feature vector for each pairing to a trained machine learning (ML) model; and
mapping the source field to a particular destination field based on similarity measures that are output by the trained ML model and that correspond to each pairing between the source field and each destination field.

9. The system of claim 8, wherein the at least one derived embedding for a given name embedding is obtained by applying a Fast Fourier Transform (FFT) to the given name embedding to generate the frequency components or by applying a Gaussian Mixture Model (GMM) to the given name embedding to generate the probability distribution components.

10. The system of claim 8, wherein determining the at least one distance measure between the corresponding derived embeddings that comprise the frequency components comprises:
bucketizing a frequency spectrum spanned by the corresponding derived embeddings; and
determining bucket-wise distance measures between the corresponding derived embeddings according to a plurality of buckets determined by the bucketizing.

11. The system of claim 8, wherein the operations further comprise:
including, in the feature vector for each pairing between the source field and each destination field, a cosine distance between the name embedding associated with the source field and the name embedding associated with the destination field.

12. The system of claim 8, wherein the at least one distance measure between the corresponding derived embeddings is determined based on a difference between a mean or a variance of (i) the frequency components or (ii) the probability distribution components in the corresponding derived embeddings.

13. The system of claim 8, wherein the name embedding for the source field and each destination field and the at least one distance measure for each pairing are concatenated into an input vector for each pairing, the input vector for each pairing being provided to the trained ML model.

14. The system of claim 8, wherein the name embedding for the source field and for each of the plurality of destination fields is generated based on selecting one or more name embeddings out of other name embeddings generated using different embedding models.

15. A non-transitory computer-readable storage medium storing instructions that, when executed by at least one processor of a computing system, cause the at least one processor to implement operations comprising:
generating a name embedding associated with a source field of a source dataset and for each of a plurality of destination fields of a destination dataset;
obtaining at least one derived embedding for each name embedding of the source field and the plurality of destination fields, wherein a derived embedding comprises a decomposition of the name embedding into (i) frequency components or (ii) probability distribution components;
for each pairing between the source field and each destination field, determining at least one distance measure between corresponding derived embeddings associated with the source field and each destination field, to form a feature vector that includes the at least one distance measure and respective name embeddings;
providing the feature vector for each pairing to a trained machine learning (ML) model; and
mapping the source field to a particular destination field based on similarity measures that are output by the trained ML model and that correspond to each pairing between the source field and each destination field.

16. The non-transitory computer-readable storage medium of claim 15, wherein the at least one derived embedding for a given name embedding is obtained by applying a Fast Fourier Transform (FFT) to the given name embedding to generate the frequency components or by applying a Gaussian Mixture Model (GMM) to the given name embedding to generate the probability distribution components.

17. The non-transitory computer-readable storage medium of claim 15, wherein determining the at least one distance measure between the corresponding derived embeddings that comprise the frequency components comprises:
bucketizing a frequency spectrum spanned by the corresponding derived embeddings; and
determining bucket-wise distance measures between the corresponding derived embeddings according to a plurality of buckets determined by the bucketizing.

18. The non-transitory computer-readable storage medium of claim 15, wherein the operations further comprise:
including, in the feature vector for each pairing between the source field and each destination field, a cosine distance between the name embedding associated with the source field and the name embedding associated with the destination field.

19. The non-transitory computer-readable storage medium of claim 15, wherein the at least one distance measure between the corresponding derived embeddings is determined based on a difference between a mean or a variance of (i) the frequency components or (ii) the probability distribution components in the corresponding derived embeddings.

20. The non-transitory computer-readable storage medium of claim 15, wherein the name embedding for the source field and each destination field and the at least one distance measure for each pairing are concatenated into an input vector for each pairing, the input vector for each pairing being provided to the trained ML model.
